(19) United States
(12) Patent Application Publication
(10) Pub. No.: US 2014/0200949 A1
(43) Pub. Date: Jul. 17, 2014

(54) DYNAMICALLY ORDERING TASKS IN A TASK LIST BASED ON INDICATIONS OF IMPORTANCE TO THE USER

(71) Applicant: International Business Machines Corporation, Armonk, NY (US)

(72) Inventors: Ethan L. Perry, Lexington, MA (US); Andrew L. Schirmer, Andover, MA (US)

(73) Assignee: International Business Machines Corporation, Armonk, NY (US)

(21) Appl. No.: 14/063,726

(22) Filed: Oct. 25, 2013

Related U.S. Application Data
(63) Continuation of application No. 13/744,119, filed on Jan. 17, 2013.

(51) Int. Cl. G06Q 10/06

(52) U.S. Cl. CPC G06Q 10/06316
USPC 705/7.26

(57) ABSTRACT

A method, system and computer program product for dynamically ordering tasks in a task list based on the user's indications of importance. Tasks are ordered in the task list based on identifying “indicators of importance” related to the particular task in question. These “indicators of importance” (e.g., topics, people) are derived from the task (e.g., call Mary Brown) and/or from external sources. A score or value is then assigned to these indicators of importance based on the user's deemed importance to such an indicator of importance, where such deemed importance may be determined by monitoring the user's interactions with data items (e.g., e-mails, reports), such as involving the indicator of importance. A composite score for each task may then be compiled based on the scores assigned to the indicators of importance associated with the task. The tasks will then be ordered based on these composite scores.

### CROSS-REFERENCE TO RELATED APPLICATIONS

The present application is a continuation application of pending U.S. patent application Ser. No. 13/744,119, which was filed on Jan. 17, 2013, which is assigned to the assignee of the present invention. The present application claims priority benefits to U.S. patent application Ser. No. 13/744,119.

### TECHNICAL FIELD

The present invention relates generally to task management applications, and more particularly to dynamically ordering tasks in a task list based on the indications of importance to the user.

### BACKGROUND

Task management applications allow users the ability to manage tasks, such as defining, categorizing, organizing and tracking the tasks. A group of tasks to be completed may be listed in a list referred to as a “task list.” The task list is an inventory tool which serves as an alternative or supplement to the user's memory.

In order for a task list to be manageable and effective, the tasks deemed to be “most important” should be quickly and easily identified in the task list, such as by listing them towards the top of the list prior to tasks deemed to be “less important.” The greater the number of tasks listed in the task list, the greater the importance in having the “most important” tasks be quickly and easily identified. By not having a well-ordered task list, the user may waste much time in searching the task list for a task that needs attention.

Task management applications provide many fields to characterize the tasks, such as priority (e.g., high priority), due date (e.g., due date of task), folder (e.g., store the task in a folder, such as “Project A”), star (e.g., star a task to indicate level of importance), context (e.g., set the context of the task, such as home), goal (e.g., set a goal, such as exercising more), status, tag, due date, start date, length (e.g., length the user expects to complete the task), location (e.g., location for the task to be completed), etc. By allowing the user to characterize the tasks using such fields, the user may be able to order tasks in a list based on selecting one or more of these fields. While this provides the user some degree of control over which tasks are to be listed, including its order, it also requires the user to understand the ramifications of their choice. If the user enters the data in these task fields inconsistently, then the order of the tasks based on the selected field(s) may not accurately reflect what the user deems to be important. Furthermore, the manual process of entering such data is burdensome to the user and requires the user to repeatedly update the data to keep it up-to-date as conditions change. Additionally, as aspects of the user's circumstances change, such as a temporary need to attend to urgent tasks related to a particular project ahead of an otherwise more important project, existing task management applications are unable to adapt dynamically and continue to show the user the previous view of tasks that suddenly are not of interest to the user.

### BRIEF SUMMARY

In one embodiment of the present invention, a method for dynamically ordering tasks in a task list comprises receiving a plurality of tasks. The method further comprises identifying indicators of importance associated with each of the plurality of tasks. Additionally, the method comprises generating a score for each identified indicator of importance associated with each of the plurality of tasks. In addition, the method comprises generating, by a processor, a composite score for each of the plurality of tasks based on the scores for the identified indicators of importance associated with each of the plurality of tasks, respectively.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a network system configured in accordance with an embodiment of the present invention;

FIG. 2 illustrates a hardware configuration of a task management system configured in accordance with an embodiment of the present invention; and

FIG. 3 is a flowchart of a method for dynamically ordering tasks in a task list based on the user's indications of importance in accordance with an embodiment of the present invention.

### DETAILED DESCRIPTION

The present invention comprises a method, system and computer program product for dynamically ordering tasks in a task list based on the user's indications of importance. In one embodiment of the present invention, tasks are ordered in the task list based on identifying “indicators of importance” related to the particular task in question. These “indicators of importance” (e.g., topics, people, roles, relationships, places, action types, object types, significant events, dates and scopes) are derived from the task (e.g., call Mary Brown) and/or from external sources. A score or value is then assigned to these indicators of importance based on the user's deemed importance to such an indicator of importance, where such deemed importance may be determined by monitoring the user's interactions with data items (e.g., e-mails, reports), such as involving the indicator of importance. A composite score for each task may then be compiled based on the scores assigned to the indicators of importance associated with the task. The tasks will then be ordered based on these composite scores. In this manner, the tasks will be dynamically ordered in the task list without requiring the user to manually input field information, decide task priorities, understand field interactions or choose from complex combinations of sort orders.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

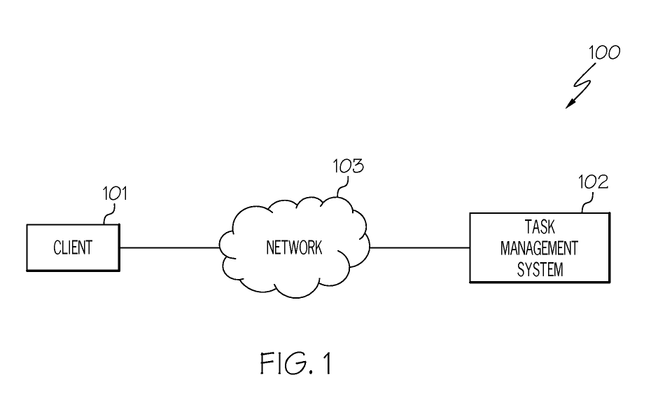

Referring now to the Figures in detail, FIG. 1 illustrates a network system 100 configured in accordance with an embodiment of the present invention. Referring to FIG. 1, network system 100 includes a client 101 connected to task management system 102 via network 103. Client 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with task management system 102.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

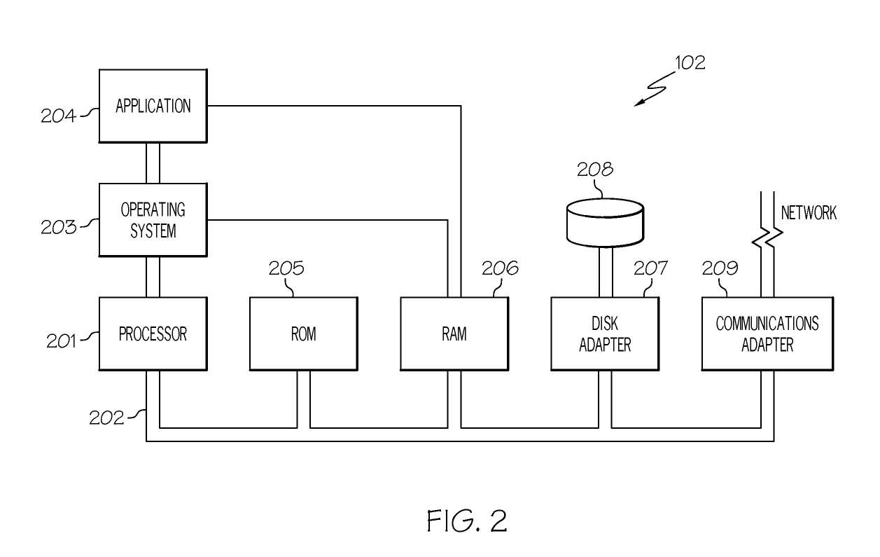

System 100 further includes a task management system 102 configured to dynamically order the tasks in a task list based on the user's indications of importance without requiring the user to manually input field information, decide task priorities, understand field interactions or choose from complex combinations of sort orders as discussed further below. A description of the hardware configuration of task management system 102 is provided below in connection with FIG. 2.

System 100 is not to be limited in scope to any one particular network architecture. System 100 may include any number of clients 101, task management systems 102 and networks 103.

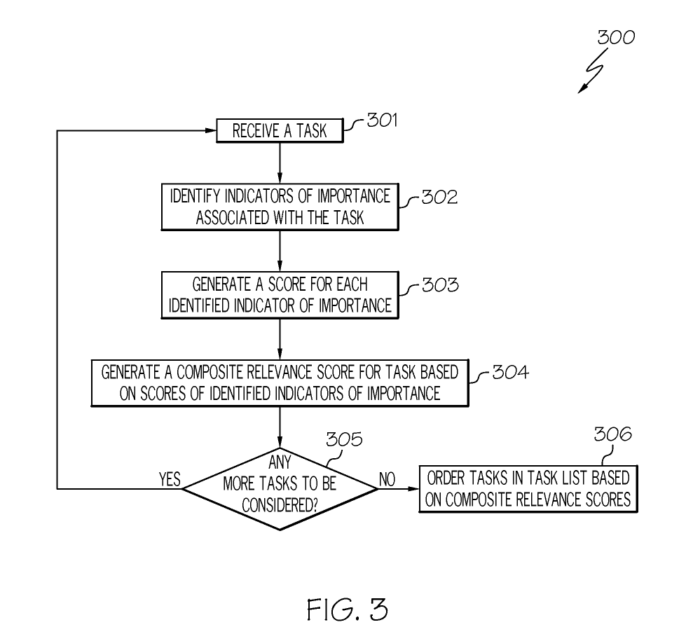

Referring now to FIG. 2, FIG. 2 illustrates a hardware configuration of task management system 102 (FIG. 1) which is representative of a hardware environment for practicing the present invention. Referring to FIG. 2, task management system 102 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for dynamically ordering the tasks in a task list based on the user's indications of importance, as discussed further below in association with FIG. 3.

Referring again to FIG. 2, read-only memory (“ROM”) 205 is coupled to system bus 202 and includes a basic input/output system (“BIOS”) that controls certain basic functions of task management system 102. Random access memory (“RAM”) 206 and disk adapter 207 are also coupled to system bus 202. It should be noted that software components including operating system 203 and application 204 may be loaded into RAM 206, which may be task management system's 102 main memory for execution. Disk adapter 207 may be an integrated drive electronics (“IDE”) adapter that communicates with a disk unit 208, e.g., disk drive. It is noted that the program for dynamically ordering the tasks in a task list based on the user's indications of importance, as discussed further below in association with FIG. 3, may reside in disk unit 208 or in application 204.

Task management system 102 may further include a communications adapter 209 coupled to bus 202. Communications adapter 209 interconnects bus 202 with an outside network (network 103) thereby allowing task management system 102 to communicate with client 101 as well as to monitor the user's interactions with data items (e.g., sending status reports to a particular individual) to assign “importance scores” to the data items as discussed further below.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, task management applications provide many fields to characterize the tasks, such as priority (e.g., high priority), due date (e.g., due date of task), folder (e.g., store the task in a folder, such as “Project A”), star (e.g., star a task to indicate level of importance), context (e.g., set the context of the task, such as home), goal (e.g., set a goal, such as exercising more), status, tag, due date, start date, length (e.g., length the user expects to complete the task), location (e.g., location for the task to be completed), etc. By allowing the user to characterize the tasks using such fields, the user may be able to order tasks in a list based on selecting one or more of these fields. While this provides the user some degree of control over which tasks are to be listed, including its order, it also requires the user to understand the ramifications of their choice. If the user enters the data in these task fields inconsistently, then the order of the tasks based on the selected field(s) may not accurately reflect what the user deems to be important. Furthermore, the manual process of entering such data is burdensome to the user and requires the user to repeatedly update the data to keep it up-to-date as conditions change. Additionally, as aspects of the user's circumstances change, such as a temporary need to attend to urgent tasks related to a particular project ahead of an otherwise more important project, existing task management applications are unable to adapt dynamically and continue to show the user the previous view of tasks that suddenly are not of interest to the user.

The principles of the present invention provide a means for dynamically ordering tasks in a task list without requiring the user to manually input field information, decide task priorities, understand field interactions or choose from complex combinations of sort orders. Instead, the tasks are ordered in the task list based on identifying “indicators of importance” related to the particular task in question. These “indicators of importance” (e.g., topics, people, roles, relationships, places, action types, object types, significant events, dates and scopes) are derived from the task (e.g., call Mary Brown) and/or from external sources. A score or value is then assigned to these indicators of importance based on the user's deemed importance to such an indicator of importance, where such deemed importance may be determined by monitoring the user's interactions with data items (e.g., e-mails, reports), such as involving the indicator of importance. A composite score for each task may then be compiled based on the scores assigned to the indicators of importance associated with the task. The tasks will then be order based on these composite scores. A more detailed discussion of dynamically ordering tasks in a task list in such a manner is provided below in connection with FIG. 3.

FIG. 3 is a flowchart of a method 300 for dynamically ordering tasks in a task list based on the user's indications of importance in accordance with an embodiment of the present invention.

Referring to FIG. 3, in conjunction with FIGS. 1-2, in step 301, task management system 102 receives a task (e.g., call Mary Brown). The task may be created by the user or may be generated by an external system.

In step 302, task management system 102 identifies indicators of importance associated with the task received in step 301. “Indicators of importance” (e.g., topics, people, roles, relationships, places, action types, object types, significant events, dates and scopes) are derived from the task (e.g., call Mary Brown) and/or from external sources. Indicators of importance are aspects of the task that may be used to assess an importance measure (“composite score”) to the task as discussed further below. In one embodiment, indicators of importance are identified by performing a keyword or semantic analysis of a statement associated with the task. For example, in the task of “call Mary Brown,” task management system 102 would determine that Mary Brown is the person associated with the task. In another example, in the task of “finish report by next Friday,” next Friday as well as report could be indicators of importance. Indicators of importance may also be identified based on monitoring the user's interactions with data items. “Data items,” as used herein, refer to objects of interest that involves a task, whether a person, place or thing (e.g., library, grocery store, person, book, report, etc.). For example, task management system 102 may monitor the user interactions with a data item, such as a status report. If the user always sends the status report to John Smith, then when task management system 102 analyzes the task “send status report,” task management system 102 may infer that the status report is to be sent to John Smith. In such a scenario, the indicator of importance, John Smith, is inferred based on the monitored interactions of the user. It is noted for clarity that an external system rather than task management system 102 may monitor the interactions of the user and provide such information to task management system 102. Other examples of identifying indicators of importance include, but not limited to, analyzing the tags or links in the task consisting of words or phrases. The principles of the present invention concerning identifying indicators of importance are not to be limited to the examples discussed above but instead are to include any mechanism for identifying indicators of importance in the task whereby such aspects of the task can be used to determine an “importance” of the task to the user.

In step 303, task management system 102 generates a score for each identified indicator of importance associated with the task received in step 301. In one embodiment, such scores may be generated based on monitoring the interactions of the user with various data items. For example, the frequency, time and type of information that the user is interacting may be used to assess an importance, such as via a score, for the data item. For instance, the greater the time duration or the greater number of times the user interacts with a data item, generally the more important the data item is to the user. The principles of the present invention are to include any mechanism for generating an importance value or score for an indicator of importance. In one embodiment, the value or score of an indicator of importance is based on its relative value to other such items in an overall value list. In one embodiment, the higher the value or score of the indicator of importance, the more important the indicator of importance is to the user. In another embodiment, the higher the value or score of the indicator of importance, the less important the indicator of importance is to the user. In one embodiment, such scoring of the indicators of importance can be normalized to fit within a certain value range, such as 1 to 100.

In step 304, task management system 102 generates a composite relevance score for the task based on the scores for the identified indicators of importance associated with the task. For example, task management system 102 may calculate the average score assessed to the identified indicators of importance as corresponding to a score referred to herein as the “composite relevance score.” The composite relevance score is a measure of importance that is used to assess the importance of the task to the user.

In step 305, a determination is made by task management system 102 as to whether there are any more tasks that need to be considered when ordering the tasks in the task list. If there are other tasks that need to be considered when ordering the tasks in the task list, then task management system 102 receives an additional task in step 301 which is later analyzed as discussed above.

If, however, there are no other tasks that need to be considered when ordering the tasks in the task list, then, in step 306, task management system 102 orders the tasks in a task list based on the composite relevance scores, where the tasks associated with a higher composite relevance score are listed higher than those with a lower composite relevance score. In this manner, the tasks are ordered in a task list without requiring the user to manually input field information, decide task priorities, understand field interactions or choose from complex combinations of sort orders. Furthermore, the ordering of the tasks in the task list is dynamic in that the scores for the identified indicators of importance may be constantly updated based on user activity thereby necessitating updating the composite relevance scores of the tasks which may cause the tasks to be reordered in the task list. For example, the interactions of the user with various data items may be constantly monitored thereby ensuring that the importance value or score assigned to the indicators of importance are appropriate, and if not, can be modified accordingly. Modification of the scores assigned to the indicators of importance will result in generating a newly assigned composite relevance score for the tasks associated with these indicators of importance. The tasks will then be reordered in the task list so that the tasks associated with a higher composite relevance score are listed higher than those with a lower composite relevance score.

In one embodiment, task management system 102 has the ability to display views of what is unimportant for the purpose, for example, of helping the user see and remove unnecessary tasks cluttering up the list.

In one embodiment, the assessment of the composite relevance scores for the tasks may be used to filter out tasks that are deemed to be of such low importance that they should be ignored and should not be listed in the task list.

In one embodiment, when tasks have the same composite relevance score, the task that is associated with a more important person will be ranked higher in the task list than the other task.

In one embodiment, the user may select a minimum score for the composite relevance score, such as via knobs or sliders, for the tasks to be listed in the task list. For example, those tasks with a composite relevance score that is less than the selected threshold score will not be included in the task list.

In some implementations, method 300 may include other and/or additional steps that, for clarity, are not depicted. Further, in some implementations, method 300 may be executed in a different order presented and that the order presented in the discussion of FIG. 3 is illustrative. Additionally, in some implementations, certain steps in method 300 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for dynamically ordering tasks in a task list, the method comprising:
receiving a plurality of tasks;
identifying indicators of importance associated with each of said plurality of tasks;
generating a score for each identified indicator of importance associated with each of said plurality of tasks; and
generating, by a processor, a composite score for each of said plurality of tasks based on said scores for said identified indicators of importance associated with each of said plurality of tasks, respectively.

2. The method as recited in claim 1 further comprising:
ordering said plurality of tasks in said task list based on said composite scores for said plurality of tasks.

3. The method as recited in claim 1, wherein said indicators of importance comprise one or more of the following: topics, people, roles, relationships, places, action types, object types, significant events, dates and scopes.

4. The method as recited in claim 1, wherein said indicators of importance associated with a task are identified by performing a keyword or semantic analysis of a statement associated with said task.

5. The method as recited in claim 1, wherein a score for an identified indicator of importance is based on monitoring interactions of said user with various data items.

6. The method as recited in claim 1, wherein a score for an identified indicator of importance is based on its relative value with respect to other such items in an overall value list.

7. The method as recited in claim 1, wherein a first task and a second task have a same composite score, wherein said first task is ranked higher than said second task in response to said first task being associated with a more important person than said second task.
